(19) United States
(12) Patent Application Publication
(10) Pub. No.: US 2013/0051604 A1
(43) Pub. Date: Feb. 28, 2013

(54) SPEAKER

(71) Applicant: Shigeyuki SAKAI, NAGANO (JP)

(72) Inventor: Shigeyuki SAKAI, NAGANO (JP)

(73) Assignee: MINEBEA CO., LTD., KITASAKU-GUN (JP)

(21) Appl. No.: 13/591,586

(22) Filed: Aug. 22, 2012

(30) Foreign Application Priority Data
Aug. 30, 2011 (JP) 2011-187546

(51) Int. Cl. H04R 9/06

(52) U.S. Cl. 381/401

(57) ABSTRACT

A speaker includes: a plurality of voice coil bobbins, each of which includes a voice coil; a diaphragm, which provided with the plurality of voice coil bobbins; and a wiring material fixed to the diaphragm, wherein each of the plurality of the voice coil bobbins is disposed next to an next voice coil bobbin, wherein the wiring material is fixed to a portion of the diaphragm between the next voice coil bobbin, wherein a one-side conductive line of voice coil bobbins is extended in a direction toward the next voice coil bobbin and is connected to the wiring material that is disposed between the voice coil bobbins, wherein the other-side conductive line is extended in another direction different from the direction of the one-side conductive line, and wherein the each of the plurality of voice coils is connected in series.

### CROSS-REFERENCE TO RELATED APPLICATION

This application claims priority from Japanese Patent Application No. 2011-187546 filed on Aug. 30, 2011, the entire subject matter of which is incorporated herein by reference.

### TECHNICAL FIELD

This disclosure relates to a speaker, and specifically, to a speaker having a plurality of drive units including voice coils.

### BACKGROUND

Speakers have been widely used in various electronic apparatuses such as home audio systems, in-car audio systems, personal computers, portable phones, and game machines. Electronic apparatuses have been reduced in size and weight, and thus compact speakers, specifically, elongated speakers are required.

Since it is difficult to incorporate large magnetic circuits into the elongated speakers, it is general to divide a large magnetic circuit into a plurality of small

In some of these speakers having a plurality of magnetic circuits, parallel connection is possible without using tinsel wires. However, even in the case where any tinsel wires are not used, it is necessary to use special components for wiring of the speakers.

In regard to this problem, Japanese Patent No. 3652782 discloses a structure of a speaker which includes a terminal that is provided at the center of a diaphragm, and tinsel wires that are mounted on voice coil bobbins and are guided to the terminal. In this speaker, two voice coils are connected to each other by a terminal plate provided between the two voice coils. In other words, two voice coils are connected to one input terminal.

### SUMMARY

However, since the tinsel wires are extracted from between spiders and the diaphragm, the structure of the speaker disclosed in Japanese Patent No. 3652782 cannot be used for a speaker having a small depth. Further, in a case where the directions (winding directions) of leading lines of adjacent voice coils are the same, since a tinsel wire connected to one voice coil is bent at 180 degrees and is attached, the tinsel wire or the voice coil may be strained. Meanwhile, in a case where leading lines of adjacent voice coils are disposed to face each other (a case where the directions of the voice coils are opposite to each other), since it is necessary to magnetize magnetic circuits into opposite phases, the configuration of the speaker is complicated and troublesome.

With taking into consideration the above, this disclosure provides a high-performance speaker having a smaller depth and a smaller number of components.

In view of the above, a speaker comprises: a plurality of voice coil bobbins, each of which includes a voice coil having positive and negative lines; a diaphragm, which provided with the plurality of voice coil bobbins; and a wiring material fixed to the diaphragm, wherein each of the plurality of the voice coil bobbins is disposed next to an next voice coil bobbin of the plurality of the voice coil bobbins to be adjacent to each other, wherein the wiring material is fixed to a portion of the diaphragm between the next voice coil bobbin, wherein a one-side conductive line of each of the plurality of voice coil bobbins is extended in a direction toward the next voice coil bobbin and is connected to the wiring material that is disposed between the voice coil bobbins, wherein the other-side conductive line is extended in another direction different from the direction of the one-side conductive line, and wherein the each of the plurality of voice coils is connected in series.

In the above-described speaker, the speaker further may comprises tinsel wires, which are respectively connected to one of the conductive lines that configures both end portions of the plurality of voice coils connected in series, and which are respectively disposed on a rear side of the diaphragm, wherein one end portion of each of the tinsel wires may be extracted from a front side of the diaphragm, and the other end portion of each of the tinsel wire is connected to a terminal disposed a fixed portion of the speaker so that a portion between the one end portion and the other end portion is bendable.

In the above-described speaker, the wiring material may be disposed so that both end portions of the wiring material pass the diaphragm from a rear side of the diaphragm to a front side of the diaphragm, and at least one of the conductive lines of each of the voice coils may be connected to the end portions of the wiring material extracted from the front side of the diaphragm.

In the above-described speaker, the wiring material may be disposed so that both end portions of the wiring material pass the diaphragm from a front side of the diaphragm to a rear side of the diaphragm, and at least one of the conductive lines of each of the voice coils may be connected to the end portions of the wiring material at the front side of the diaphragm.

According to this disclosure, since one side of the conductive wires of each voice coil is connected to the wiring material, wiring is performed toward adjacent voice coil bobbins. Therefore, it is possible to provide a high-performance speaker having a smaller depth and a smaller number of components.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a front view illustrating a speaker according to an embodiment of this disclosure;

FIG. 2 is a sectional side view illustrating the speaker;

FIG. 3 is a cross-sectional view taken along a line A-A of FIG. 1;

FIG. 4 is a front view illustrating a diaphragm unit;

FIG. 5 is a side view illustrating the diaphragm unit;

FIG. 6 is a rear view illustrating the diaphragm unit;

FIG. 7 is a front view illustrating a frame with a drive unit attached thereto; and

FIG. 8 is a front view illustrating the frame assembled with the diaphragm unit.

### DETAILED DESCRIPTION

Hereinafter, a speaker according to an embodiment of this disclosure will be described.

### Embodiment

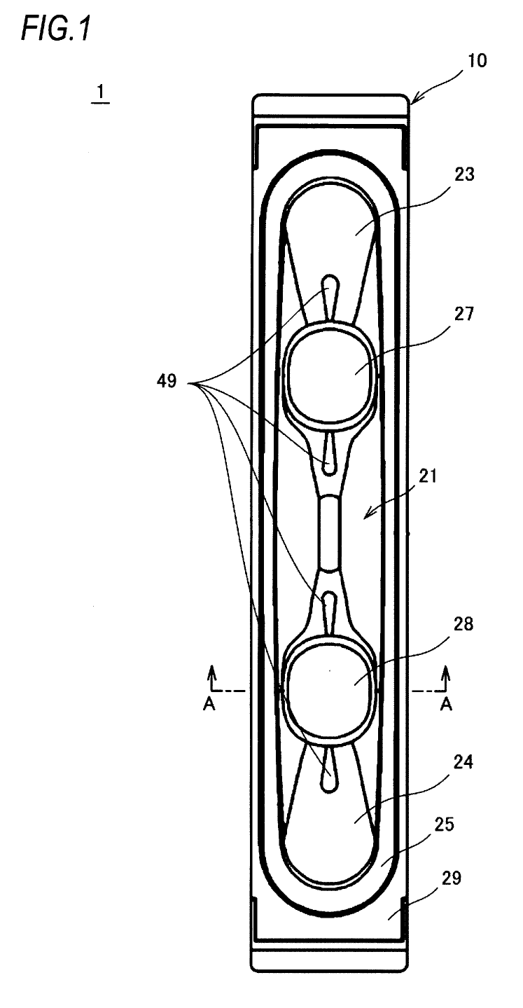

FIG. 1 is a front view illustrating a speaker 1 according to an embodiment of this disclosure.

As shown in FIG. 1, the speaker 1 has an elongated outer shape as seen from a side of a front face (hereinafter also referred to as a front side).

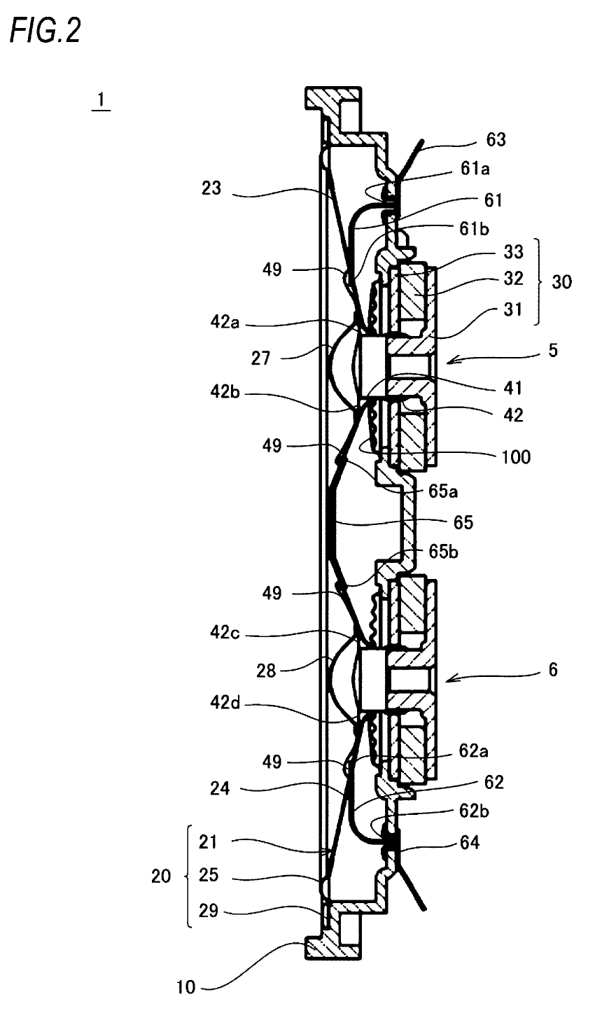

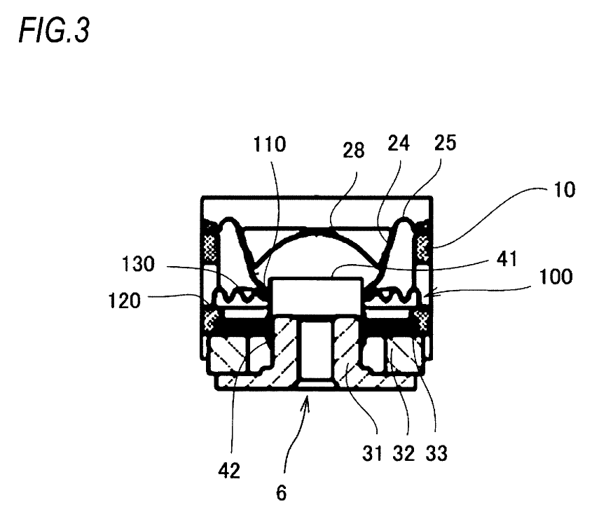

FIG. 2 is a sectional side view illustrating the speaker 1. FIG. 3 is a cross-sectional view taken along a line A-A of FIG. 1.

Hereinafter, the structure of the speaker 1 will be described with reference to FIGS. 1 to 3.

As shown in FIG. 2, the speaker 1 having an elongated shape includes two drive units 5 and 6. Each of the drive units 5 and 6 is attached to a side of a rear face (which is the right side in FIG. 2, and will be hereinafter referred to as a rear side) of the speaker 1. As will be described below, each of the drive units 5 and 6 includes a voice coil 42.

The speaker 1 generally includes a frame 10, a diaphragm unit 20, and the two drive units 5 and 6. The diaphragm unit 20 includes a diaphragm 21, an surround 25, and a gasket 29. Dust caps 27 and 28 are attached to the diaphragm unit 20. The drive unit 5 includes a magnetic circuit 30, a voice coil bobbin 41, the voice coil 42, and a spider 100. The drive unit 6 has the same configuration as that of the drive unit 5.

The drive units 5 and 6 are disposed at almost symmetrical upper and lower positions with respect to the center portion of the frame 10, respectively, so that they are arranged in vertical line. In other words, the drive units 5 and 6 are arranged side by side so that their voice coil bobbins 41 is disposed next to each other.

The magnetic circuit 30 includes a bottom yoke 31, a magnet 32, and a top plate 33. The magnetic circuit 30 is fixed to the frame 10. The magnetic circuit 30 is an external magnet type. The magnet 32 is disposed around a central cylindrical portion of the bottom yoke 31 so that it is interposed between a bottom portion of the bottom yoke 31 and the top plate 33. Therefore, a magnetic gap is formed between a central cylindrical portion of the bottom yoke 31 and the inner circumferential portion of the top plate 33. The magnetic circuit 30 may be an internal magnetic type.

Each voice coil 42 is wound on the peripheral surface of a lower portion (a portion on the right side in FIG. 2) of a corresponding voice coil bobbin 41. In the present embodiment, the voice coil bobbins 41 are substantially cylindrical. Together with the voice coil bobbins 41, the voice coils 42 are positioned in the magnetic gaps of the magnetic circuits 30. The voice coil bobbins 41 are supported via the spiders 100 by the frame 10.

The diaphragm 21 is attached to the gasket 29 via the surround 25, so that the diaphragm unit 20 is configured. The gasket 29 is fixed to the frame 10, so that the diaphragm unit 20 is attached to the frame 10. An inner circumferential portion of the surround 25 is bonded to an outer circumferential portion of the diaphragm 21. As shown in FIG. 1, in the present embodiment, an outer circumferential edge of the surround 25 has an oval shape formed by two semicircular arcs and almost parallel two straight lines in a plan view. On the other hand, the frame 10 is substantially rectangular. The gasket 29 is formed to cover a gap between the outer circumferential edge of the surround 25 and an attachment face of the frame 10. The outer circumferential edge of the surround 25 is bonded to the gasket 29. In other words, the diaphragm 21 is held via the surround 25 by the gasket 29.

As shown in FIG. 2, the diaphragm 21 includes two cone portions 23 and 24, which correspond to the two drive units 5 and 6, and are formed integrally with the diaphragm 21. In other words, in the diaphragm 21, a portion corresponding to the drive unit 5 and a portion corresponding to the drive unit 6 are deep (they cave in from the front face of the speaker 1 so as to be close to the rear side). Further, the diaphragm 21 is formed so that a portion closer to the outer circumferential portion of the diaphragm 21 is shallower, that is, a portion closer to the outer circumferential portion of the diaphragm 21 is close to the front face (a face at the left end in FIG. 2) of the speaker 1. Also at a portion between the drive units 5 and 6, that is, the center portion of the speaker 1, the diaphragm 21 is shallow.

The cone portion 23 is connected to an upper portion of the voice coil bobbin 41 (the left portion of the voice coil bobbin 41 in FIG. 2) of the drive unit 5. Also, the cone portion 24 is connected to an upper portion of the voice coil bobbin 41 of the drive unit 6. Therefore, the two voice coil bobbins 41 are moved forward and backward (left and right in FIG. 2) and is vibrated. As a result, the diaphragm 21 vibrates. The dust caps 27 and 28 are bonded to the front sides of the cone portions 23 and 24, respectively, thereby covering the voice coil bobbins 41.

As shown in FIG. 3, each spider 100 includes an inner circumferential portion 110, an outer circumferential portion 120, and a corrugation portion 130. The spiders 100 have a substantially oval shape having a large-diameter portion and a small-diameter portion. Each spider 100 is disposed so that the large-diameter portion is positioned in a longitudinal direction of the speaker 1, that is, in a vertical direction (a direction perpendicular to the plane of paper in FIG. 3). The corrugation portion 130 is connected to the inner circumferential portion 110 and the outer circumferential portion 120. The corrugation portion 130 includes a plurality of peak portions and trough portions. The inner circumferential portion 110 is bonded to the outer circumferential portion of a corresponding voice coil bobbin 41. The outer circumferential portion 120 is bonded to the frame 10. Therefore, the diaphragm 21, and the voice coil bobbins 41 and the voice coils 42 of the drive units 5 and 6 configure a vibrating system of the speaker 1, which is supported by the two spiders 100 and the surround 25.

As shown in FIG. 2, at the center portion of the diaphragm 21, a wiring material 65 is fixed. In the present embodiment, the voice coil 42 of the drive unit 5 and the voice coil 42 of the drive unit 6 are connected in series via the wiring material 65.

The wiring material 65 is attached to the rear side of the diaphragm 21. An end portion 65a of the wiring material 65 on a side of drive unit 5 enters a lower portion of the cone portion 23 (a portion on the side of drive unit 6) and passes through the diaphragm 21 to be extracted from the front side of the diaphragm 21. Also, an end portion 65b of the wiring material 65 on the side of drive unit 6 enters an upper portion of the cone portion 24 (a portion on the side of drive unit 5) and passes through the diaphragm 21 to be extracted from the front side of the diaphragm 21. In other words, the wiring material 65 is disposed so that the both end portions 65a and 65b enter the rear side of the diaphragm 21 and are extracted from the front side of the diaphragm 21.

At both end portions of the diaphragm 21 in the longitudinal direction (both end portions in the vertical direction), tinsel wires 61 and 62 are disposed. The tinsel wire 61 is disposed above the diaphragm 21. One end portion 61a of the tinsel wire 61 is connected to a terminal 63 provided at the rear face of the frame 10. The other end portion 61b of the tinsel wire 61 enters an upper portion of the cone portion 23 and passes through the diaphragm 21 to be extracted from the front side of the diaphragm 21, and then it is fixed to the diaphragm 21. Further, the tinsel wire 62 is disposed below the diaphragm 21. One end portion 62a of the tinsel wire 62 enters a lower portion of the cone portion 24 and passes through the diaphragm 21 to be extracted from the front side of the diaphragm 21, and then it is fixed to the diaphragm 21. The other end portion 62b of the tinsel wire 62 is connected to a terminal 64 provided at the rear face of the frame 10. The tinsel wires 61 and 62 are disposed to be bendable between the both end portions 61a and 61b and between the both end portions 62a and 62b, respectively, and to allow displacement of the diaphragm 21 with respect to the frame 10.

Positive conductive lines and negative conductive lines (leading lines) of each voice coil 42 are arranged in the same direction so that positive and negative directions becomes a direction parallel with a large-diameter axis, that is, the vertical direction, and are extracted from the front side of the diaphragm 21. As shown in FIG. 2, one conductive line 42a of two conductive lines 42a and 42b of the voice coil 42 of the drive unit 5 is disposed to extend from the voice coil bobbin 41 toward the tinsel wire 61, that is, upward. The other conductive line 42b is disposed to extend from the voice coil bobbin 41 toward the wiring material 65, that is, downward. Further, one conductive line 42c of two conductive lines 42c and 42d of the voice coil 42 of the drive unit 6 is disposed to extend from the voice coil bobbin 41 toward the wiring material 65, that is, upward. The other conductive line 42d is disposed to extend from the voice coil bobbin 41 toward the tinsel wire 62, that is, downward. In other words, the two conductive lines 42a and 42b, which are the positive and negative lines, of the voice coil 42 of the drive unit 5 are disposed to extend from the voice coil 42 in different directions, that is, upward and downward in a front view. The two conductive lines 42c and 42d, which are the positive and negative lines, of the voice coil 42 of the drive unit 6 are disposed to extend from the voice coil 42 in different directions, that is, upward and downward in a front view.

The conductive line 42a of the voice coil 42 of the drive unit 5 is connected to the end portion 61b of the tinsel wire 61 extracted from the front side of the diaphragm 21. Also, the conductive line 42b is connected to the end portion 65a of the wiring material 65 extracted from the front side of the diaphragm 21. The conductive line 42c of the voice coil 42 of the drive unit 6 is connected to the end portion 65b of the wiring material 65 extracted from the front side of the diaphragm 21. Also, the conductive line 42d is connected to the end portion 62a of the tinsel wire 62 extracted from the front side of the diaphragm 21.

The conductive line 42a with including a connection portion with the tinsel wire 61 is fixed to the front side of the diaphragm 21 by an adhesive 49 or the like. Similarly, each of the conductive lines 42b, 42c, and 42d with including a connection portion with the wiring material 65 or a connection portion with the tinsel wire 62 is fixed to the front side of the diaphragm 21 by an adhesive 49 or the like.

In the present embodiment, the voice coils 42 in the drive units 5 and 6 are wound in the same direction, and the polarities of the magnets 32 are aligned in the same direction. In other words, the magnetic circuits 30 of the drive units 5 and 6 are magnetized into the same phase. In the voice coils 42 of the drive units 5 and 6, one of the conductive lines 42b and 42c connected to the wiring material 65 is the positive polarity side, and the other is the negative polarity side.

As described above, the one-side conductive lines 42b and 42c of the voice coils 42 of the drive units 5 and 6 are connected to the wiring material 65, and the other-side conductive lines 42a and 42d of the voice coils 42 are connected to the two terminals 63 and 64 via the tinsel wires. Therefore, the voice coils 42 are connected in series between the terminals 63 and 64 so that their both ends of the voice coils 42 become the terminals 63 and 64.

With respect to the wiring material 65, a member made of the same material as the tinsel wires 61 and 62 or the like may be used, for example. As long as the wiring material 65 has flexibility to be fit into the shape of the diaphragm 21 and has electrical conductivity, the wiring material 65 is not limited thereto. For example, copper foil, a conductive line, a flexible substrate, and the like may be used as the wiring material 65.

Next, an example of the assembly process of the speaker 1 will be described.

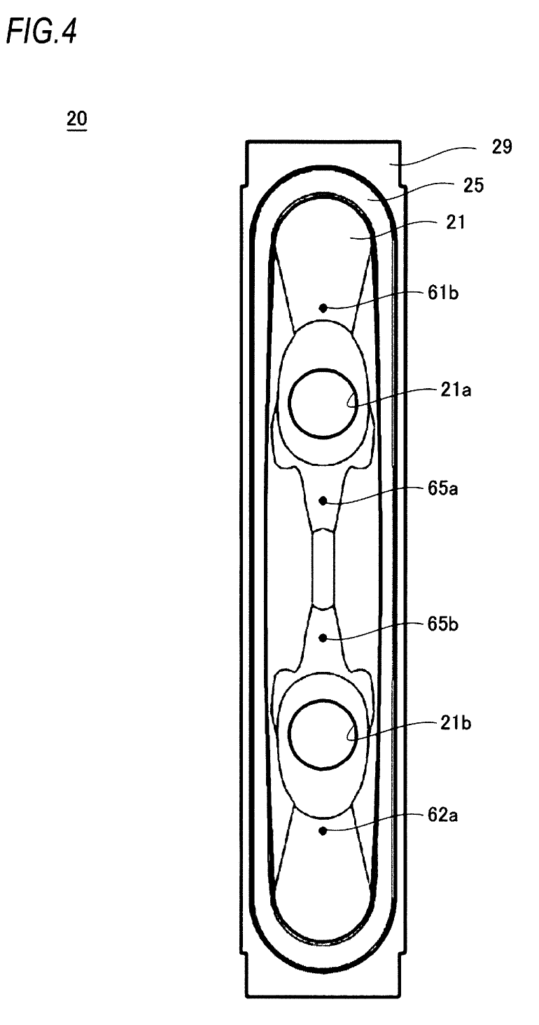

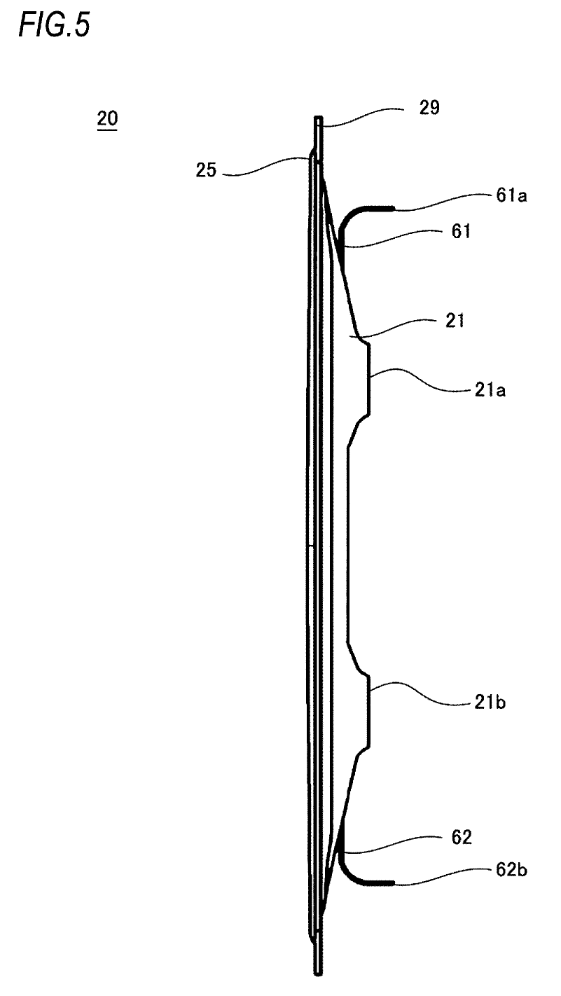

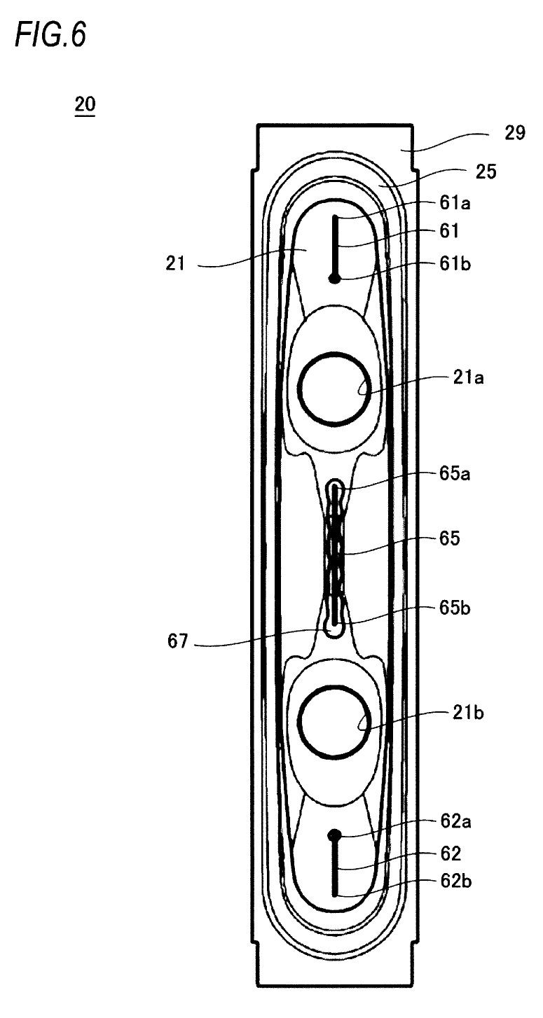

FIG. 4 is a front view illustrating the diaphragm unit 20. FIG. 5 is a side view illustrating the diaphragm unit 20. FIG. 6 is a rear view illustrating the diaphragm unit 20.

The diaphragm unit 20 is assembled in advance, and then the speaker 1 is assembled by assembling the diaphragm unit 20 to the frame 10. At that time, as shown in FIG. 6, the tinsel wires 61 and 62 and the wiring material 65 are attached to the diaphragm unit 20. The wiring material 65 is fixed to the diaphragm 21, for example, by an adhesive 67.

As shown in FIG. 4, the diaphragm 21 has holes 21a and 21b formed to allow the two voice coil bobbins 41 to be attached thereto. As seen from the front side, the end portion 61b of the tinsel wire 61 and the end portion 65a of the wiring material 65 are extracted from above and below positions of the hole 21a of the diaphragm 21. Also, the end portion 65b of the wiring material 65 and the end portion 62a of the tinsel wire 62 are extracted from above and below positions of the hole 21b of the diaphragm 21. As shown in FIG. 5, the tinsel wires 61 and 62 are held at the diaphragm 21 in a state in which one-side end portions 61b and 62a of each of the tinsel wires 61 and 62 have been extracted from the front side of the diaphragm 21 (the end portions 61b and 62a have been hidden by the diaphragm 21 in FIG. 5).

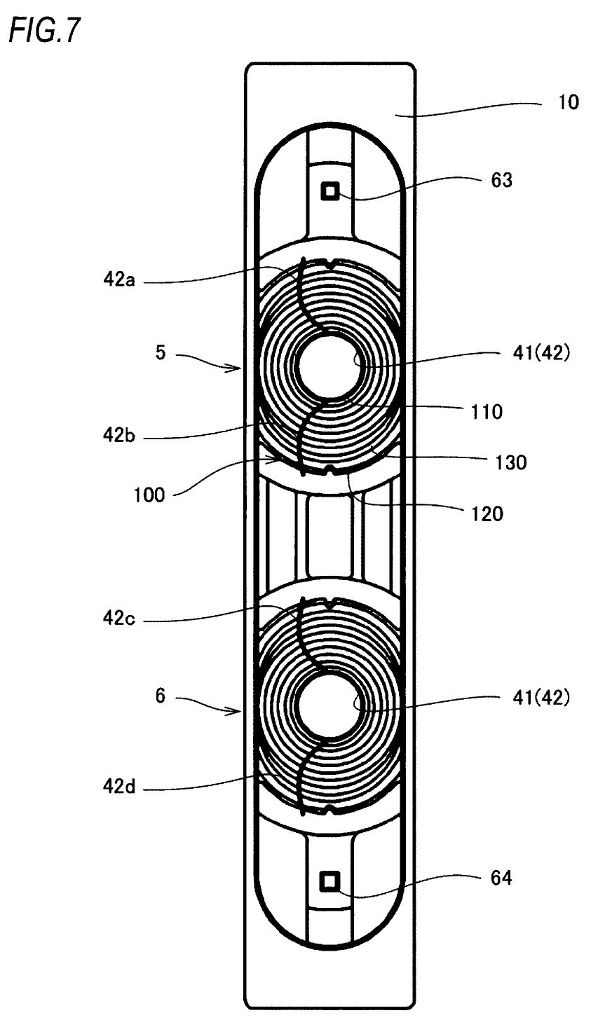

FIG. 7 is a front view illustrating the frame 10 with the drive units 5 and 6 attached thereto.

Separately from the above-mentioned diaphragm unit 20, the drive units 5 and 6 are attached to the frame 10. As shown in FIG. 7, to the frame 10, the two magnetic circuits 30 are attached, and the spiders 100 and the voice coil bobbins 41 are attached together. The conductive lines 42a and 42b and the conductive lines 42c and 42d of the voice coils 42 of the drive units 5 and 6 are disposed so that the positive and negative directions of each voice coil 42 are parallel with the large-diameter axis and arranged to extend in the same direction, and the conductive lines are extracted from the voice coil bobbins 41 upward.

Further, the terminals 63 and 64 are attached to the frame 10. The end portions 61a and 62b of the tinsel wires 61 and 62 of the diaphragm unit 20 are connected to the terminals 63 and 64.

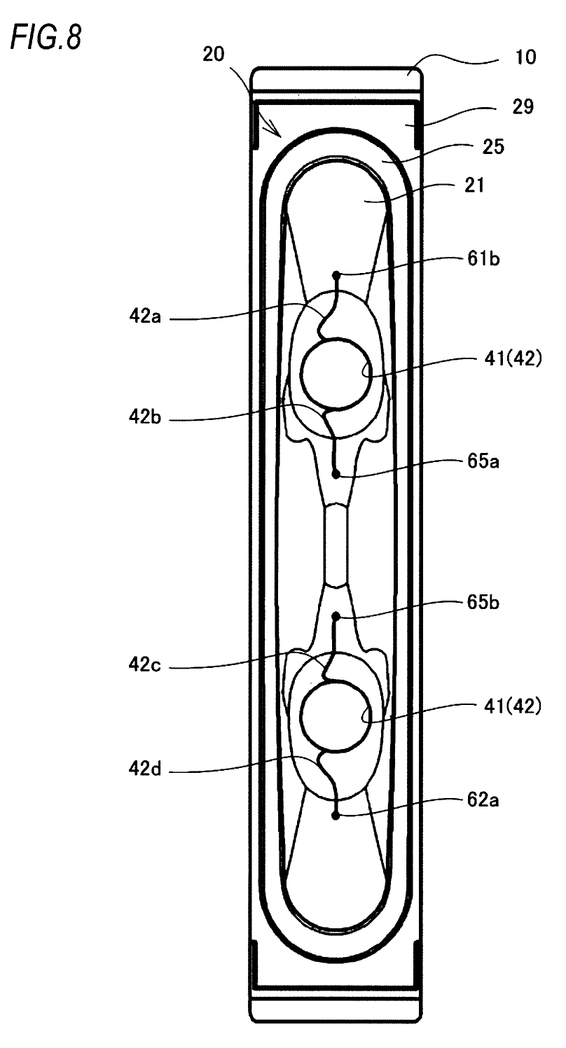

FIG. 8 is a front view illustrating the frame 10 assembled with the diaphragm unit 20.

The gasket 29 is fixed to the frame 10, and the voice coil bobbins 41 of the drive units 5 and 6 are attached to the diaphragm 21. Therefore, the diaphragm unit 20 is assembled with the frame 10. At that time, the conductive lines 42a to 42d of the voice coils 42 are extracted from the front side of the diaphragm 21.

When the diaphragm unit 20 is assembled with the frame 10, as shown in FIG. 8, wiring is performed. In other words, the conductive lines 42a and 42b of the voice coil 42 of the drive unit 5 are connected to the end portion 61b of the tinsel wire 61 and the end portion 65a of the wiring material 65, respectively. Further, the conductive lines 42c and 42d of the voice coil 42 of the drive unit 6 are connected to the end portion 65b of the wiring material 65 and the end portion 62a of the tinsel wire 62, respectively.

After the wiring is performed as described above, the conductive lines 42a to 42d are fixed to the diaphragm 21 by the adhesive 49, and the dust caps 27 and 28 are attached, so that the speaker 1 as shown in FIG. 1 is completed.

### Effects in Embodiment

In the speaker 1 configured as described above, since the voice coils 42 are connected to each other via the wiring material 65 attached to the diaphragm 21, it is possible to narrow the spaces between the spiders 100 and the diaphragm 21. Therefore, it is possible to use the spiders 100 to maintain the performance of the speaker, while reducing the depth of the speaker 1. Also, since the magnetized directions of the magnetic circuits 30 are the same between the two drive units 5 and 6, it is possible to simplify the configuration of the speaker 1, and reduce steps for assembling.

Further, in the present embodiment, the wiring material 65 for relay is fixed to the substantial center of the diaphragm 21. Therefore, the center portion of the diaphragm 21 is reinforced by the wiring material 65 and the adhesive 67, and thus the durability of the speaker 1 is improved. Furthermore, the weight balance of the diaphragm 21 is maintained, and thus a resistant to rolling phenomena of the speaker 1 is improved.

The speaker 1 is configured so that the plurality of drive units 5 and 6 can be easily connected in series without requiring a special member other than the wiring material 65. Therefore, it is possible to suppress the number of components of the speaker 1 within a small number and to improve the performance of the speaker 1.

[Others]

In the above-mentioned embodiment, most of the wiring material except for its both end portions is fixed to the rear side of the diaphragm. However, most of the wiring material may be fixed to the front side of the diaphragm. For example, the diaphragm may be disposed so that both end portions the wiring material is provided to pass the diaphragm from a front side of the diaphragm to a rear side of the diaphragm. At that time, the conductive lines of the voice coils may be connected to a portion of the wiring material at the front side of the diaphragm.

The number of drive units, that is, the number of voice coils is not limited to two, but may be more. Even in a case where the number of voice coils is three or more, adjacent voice coils may be connected via wiring materials similarly to the above-mentioned embodiment. In the case where the number of voice coils is three or more, the plurality of voice coils are arranged linearly in a front view, or may be arranged non-linearly, for example, in an L shape or a V shape. It is possible to unify the magnetized directions of the magnetic circuits and to easily connect the plurality of voice coils while suppressing the number of components.

It should be noted that the above-mentioned embodiment is merely illustrative in all aspects and does not limit this disclosure. All changes or modifications or their equivalents is to be fallen within the scope of this disclosure.

What is claimed is:

1. A speaker comprising:
a plurality of voice coil bobbins, each of which includes a voice coil having positive and negative lines;
a diaphragm, which provided with the plurality of voice coil bobbins; and
a wiring material fixed to the diaphragm,
wherein each of the plurality of voice coil bobbins is disposed next to an next voice coil bobbin of the plurality of voice coil bobbins to be adjacent to each other,
wherein the wiring material is fixed to a portion of the diaphragm between the next voice coil bobbin,
wherein a one-side conductive line of each of the plurality of voice coil bobbins is extended in a direction toward the next voice coil bobbin and is connected to the wiring material that is disposed between the voice coil bobbins,
wherein the other-side conductive line is extended in another direction different from the direction of the one-side conductive line, and
wherein the each of the plurality of voice coils is connected in series.

2. The speaker according to claim 1, further comprising:
tinsel wires, which are respectively connected to one of the conductive lines that configures both end portions of the plurality of voice coils connected in series, and which are respectively disposed on a rear side of the diaphragm,
wherein one end portion of each of the tinsel wires is extracted from a front side of the diaphragm, and the other end portion of each of the tinsel wire is connected to a terminal disposed a fixed portion of the speaker so that a portion between the one end portion and the other end portion is flexibly bendable.

3. The speaker according to claim 1,
wherein the wiring material is disposed so that both end portions of the wiring material pass the diaphragm from a rear side of the diaphragm to a front side of the diaphragm, and
wherein at least one of the conductive lines of each of the voice coils is connected to the end portions of the wiring material extracted from the front side of the diaphragm.

4. The speaker according to claim 1,
wherein the wiring material is disposed so that both end portions of the wiring material pass the diaphragm from a front side of the diaphragm to a rear side of the diaphragm, and
wherein at least one of the conductive lines of each of the voice coils is connected to the end portions of the wiring material at the front side of the diaphragm.
